(19) United States
(12) Patent Application Publication
(10) Pub. No.: US 2007/0125246 A1
(43) Pub. Date: Jun. 7, 2007

(54) Apparatus and method for controlling delivery of dampener fluid in a printing press

(75) Inventors: Douglas Joseph Dawley, Dover, NH (US); David Robert Dawley, Rochester, NH (US)

Correspondence Address: DAVIDSON, DAVIDSON & KAPPEL, LLC, 485 SEVENTH AVENUE, 14TH FLOOR, NEW YORK, NY, 10018, US

(73) Assignee: Goss International Americas, Inc., Dover, NH (US)

(21) Appl. No.: 11/293,961

(22) Filed: Dec. 5, 2005

(51) Int. Cl. B41F 7/24

(52) U.S. Cl. 101/147; 101/484

(57) ABSTRACT

An apparatus and method in accordance with the invention for automatically controlling dampener settings. Specifically, the apparatus and method detects scumming on a material to be printed and using that information to set the dampener solution flow.

### BACKGROUND

The present invention relates to printing presses and more particularly to an apparatus and method for controlling delivery of dampener fluid in a printing press, as well as to a printing press having such an apparatus.

The quality of print from a printing press depends on inking and upon dampener solution supply, which is adjusted to the inking. These variables are dependent on other parameters, such as temperature, ink composition, type of printing plate, grade of paper, changing environmental conditions, and equipment wear-and-tear, etc. While inking determines the color effect of a printed product, it is possible to influence contrast, sharpness and brilliance of the printed image by a correct supply of dampener solution.

Print quality may be optimal when the dampener solution supply is set so that the printing process takes place to deliver dampener solution just above what is known as the smearing limit. If dampening conditions cause a drop below this limit, the non-printing regions of the printing plate begin to scum. Scumming is the condition where there is not enough dampener solution on the printing plate to keep the non-image areas free of ink. However, if too much dampener solution is provided, the print quality will deteriorate. Measuring and monitoring the appropriate or optimal amount of dampener solution is challenging.

There are instruments available to measure a water film on a rotating roll, but the water films of interest are very thin and difficult to measure using these instruments. Further, the existing instrumentation systems are expensive and unsuited for industrial environments, such as the print environment. Additionally, the cost of installing one or more sensors per dampener is unpractical.

There are preset and closed loop systems available for optimizing printed optical densities. However, these optical density measurement systems are not known to sense dampener films or to automatically set the appropriate level of dampener solution.

### SUMMARY OF THE INVENTION

The present invention provides an apparatus for controlling dampener fluid flow for printing comprising:

a sensor for detecting ink on a material to be printed;

a dampener fluid metering device providing dampener fluid for a certain color;

a processor connected to the sensor, the processor controlling metering of dampener fluid and determining scumming of the certain color on the material to be printed, the processor controlling the dampener fluid metering device as a function of the scumming.

The present invention also provides a method for controlling dampener fluid flow in a printing press comprising:

operating the printing press so that an area of a material to pass through the printing press is not printed by a certain color;

reducing a feed of dampener fluid for the certain color;

determining when the area scums with the certain color using a processor; and

increasing the feed of the dampener fluid using the processor so that the area does not scum with the certain color.

Also provided is a method for controlling dampener fluid flow in a printing press comprising:

determining a first optical density of an area of a printing material to be passed through the printing press, the area being free of ink of a certain color;

operating the printing press so that the area is not intended to be printed by the certain color and monitoring the optical density of the area;

reducing a feed of dampener fluid for the certain color until the optical density surpasses the first optical density; and

increasing the feed of the dampener fluid so that the area does not scum with the certain color.

### BRIEF DESCRIPTION OF THE DRAWINGS

Further features and advantages of the invention will become apparent from the following detailed description taken in conjunction with the accompanying drawings, in which:

FIG. 1 illustrates a sample printing press overview in accordance with an embodiment of the present invention;

FIG. 2 illustrates system details in accordance with an embodiment of the present invention;

FIG. 3 illustrates a control system in accordance with an embodiment of the present invention;

FIG. 4 and is a flow chart illustrating a process for automatically controlling and setting the appropriate level of dampener solution in accordance with an embodiment of the present invention; and

FIG. 5 illustrates a sample printed target in accordance with an embodiment of the present invention.

### DETAILED DESCRIPTION

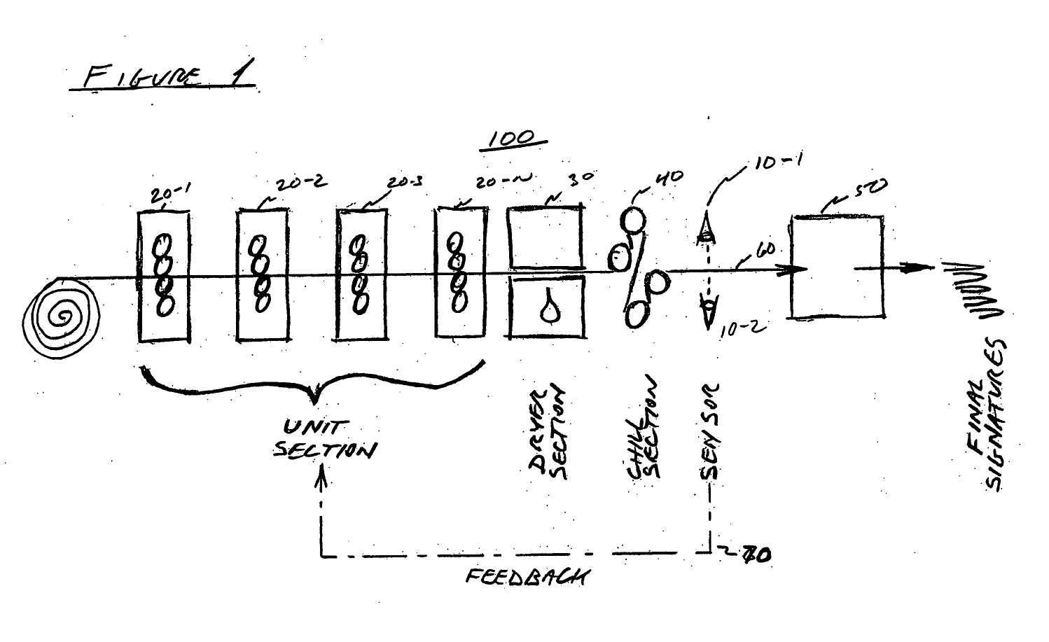

FIG. 1 illustrates an overview of a printing press 100 and sensors 10-1 and 10-2 capable of detecting ink on both sides of paper 60, in accordance with an embodiment of the present invention. As shown in FIG. 1, sensors 10-1 and 10-2 are located downstream of dryer section 30 and printing units 20-1 through 20-n. More specifically, sensors 10-1 and 10-2 are located downstream between chill section 40 and a folder 50. Also shown in FIG. 1 is a feedback loop (e.g. communications link 70) and web 60 which passes between sensors 10-1 and 10-2. Not shown in FIG. 1, for ease of illustration, is a control system and its relationship to sensors 10 and printing units 20-1 through 20-n. The control system is described in more detail below.

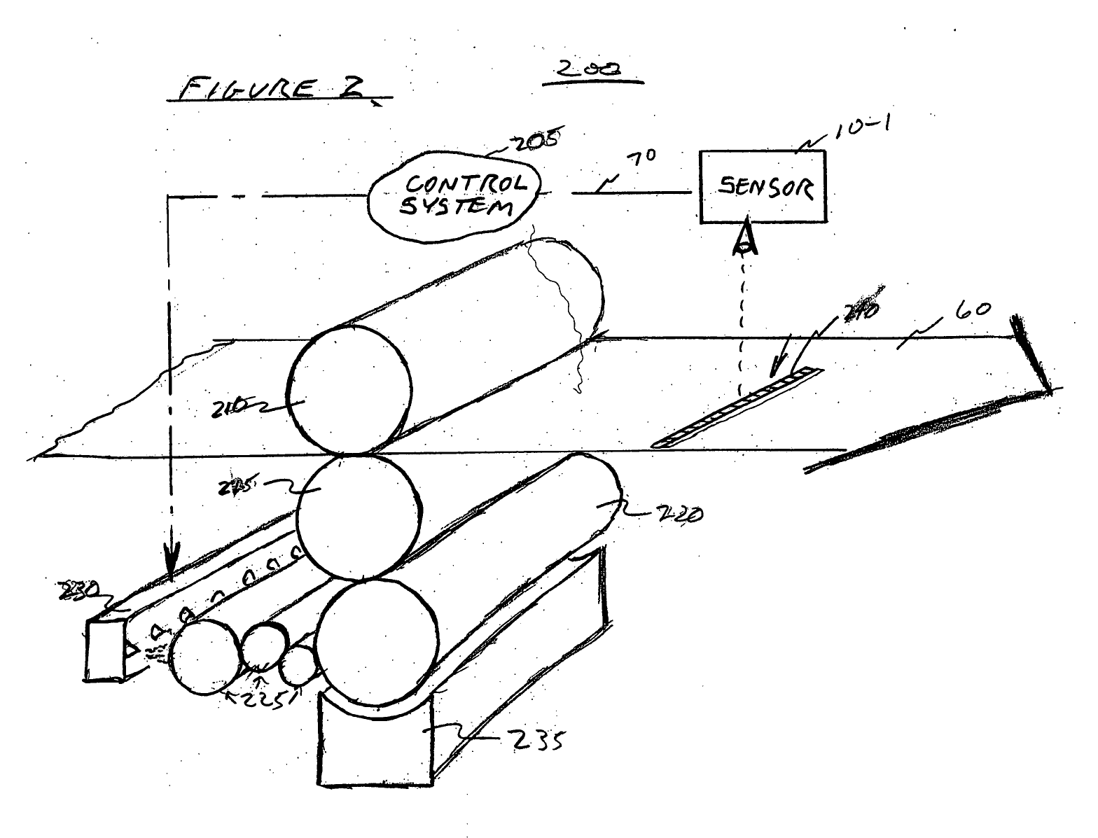

FIG. 2 is a detailed illustration of a printing unit and a dampener sensing system in accordance with an embodiment of the invention. The printing unit includes blanket cylinders 210 and 215, a plate cylinder 220, inker 235 and dampener rollers 225. In the interest of clarity, only the above mentioned printing unit components are illustrated.

The dampener sensing system includes sensor 10-1, a control system 205, communications link 70 and a dampener solution metering device 230. Sensor 10-1 is located downstream of the printing unit(s) and is capable of detecting ink on paper, for example on web 60. One type of sensor capable of sensing ink on paper is an optical density (OD) sensor which is part of an optical density measurement system. For the purpose of this discussion and this particular embodiment, the measured quantity is optical density.

In the illustrated embodiment of FIG. 2, dampener solution metering device 230 is connected to a solution source and source line. The solution can be for example a fountain solution used in a dampener system in a printing unit of a printing press which flows from the source and through the source line to the dampener solution metering device 230. After entering dampener solution metering device 230, the solution enters and exits a series of spray nozzles onto a dampener roll which transmits the fluid to one or more further dampener rolls (collectively, dampener rolls 225) which in turn transmits fluid onto a printing plate of a plate cylinder 220. For example, as illustrated schematically in FIG. 2, the spray nozzles are arranged axially across dampener rolls 225 to distribute a fluid on to the printing plate located on plate cylinder 220 of the printing unit. Inker 235 includes one or more ink sources and may include a plurality of rollers for transmitting ink to the printing plate located on plate cylinder 220. The printing plate image is transmitted to the blanket cylinder 215 and from the blanket cylinder 215 to web 60, where the optical density can be detected downstream by sensor 10-1.

Although a single dampener solution metering device 230 for the lower half of printing unit is described, it should be appreciated that a printing press may include a plurality of printing units and dampener solution metering devices for each print couple. In this embodiment of the invention, dampener solution metering device 230 includes a spray bar with spray nozzles, nozzle solenoids for controlling the rate of flow from the nozzles, and an interface for interfacing with communications link 70 which receives control signals from control system 205. However, other dampening solution delivery devices, such as brush or pure roller based devices also could be used.

The dampener solution metering device 230 can be controlled by control system 205 in response to sensor 10-1, via communications link 70. For example, in response to sensor 10-1, control system 205 can send a signal to dampener solution metering device 230 to increase or decrease the solenoid frequency of the nozzles, resulting in an increased or decreased flow rate of dampener solution.

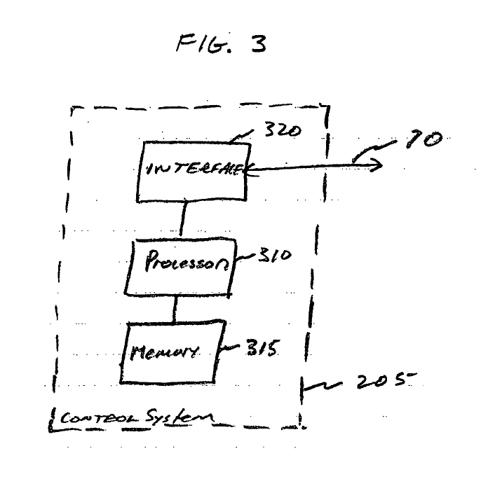

In accordance with embodiments of the present invention, control system 205 automatically sets and adjusts the appropriate dampener solution level. Referring to FIG. 3, a control system 205 includes processor 310 of conventional design, which is connected to memory 315 and interface 320. Memory 315 may store both the program and data. In accordance with the invention, processor 310 receives data from sensor 10-1, representing measured quantities of optical density of the web, via interface 320 and communications link 70. The processor can also identify or provide the location of the target strip, for example via sensor 10-1, another sensor or an angular position of the printing device for the target strip.

The measured quantities of optical density sent to processor 310 via interface 320 and may be stored in memory 315. Such data is processed by processor 310 in accordance with a program stored in memory 315 which is described below. In response to such data, processor 310 causes dampener solution metering device 230 to control the flow rate of fluid from the spray nozzles.

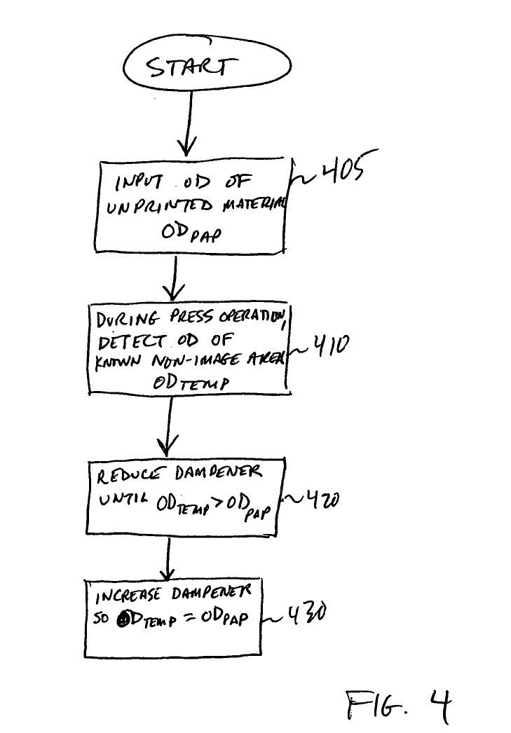

In one preferred method of the present invention as described in FIG. 4, the optical density (OD_{PAP}) of an unprinted material, for example paper, is input in step 405, preferably by the sensor 10-1 determining the optical density of the unprinted paper. Alternately, OD_{PAP} could be input from a stored value or by an operator.

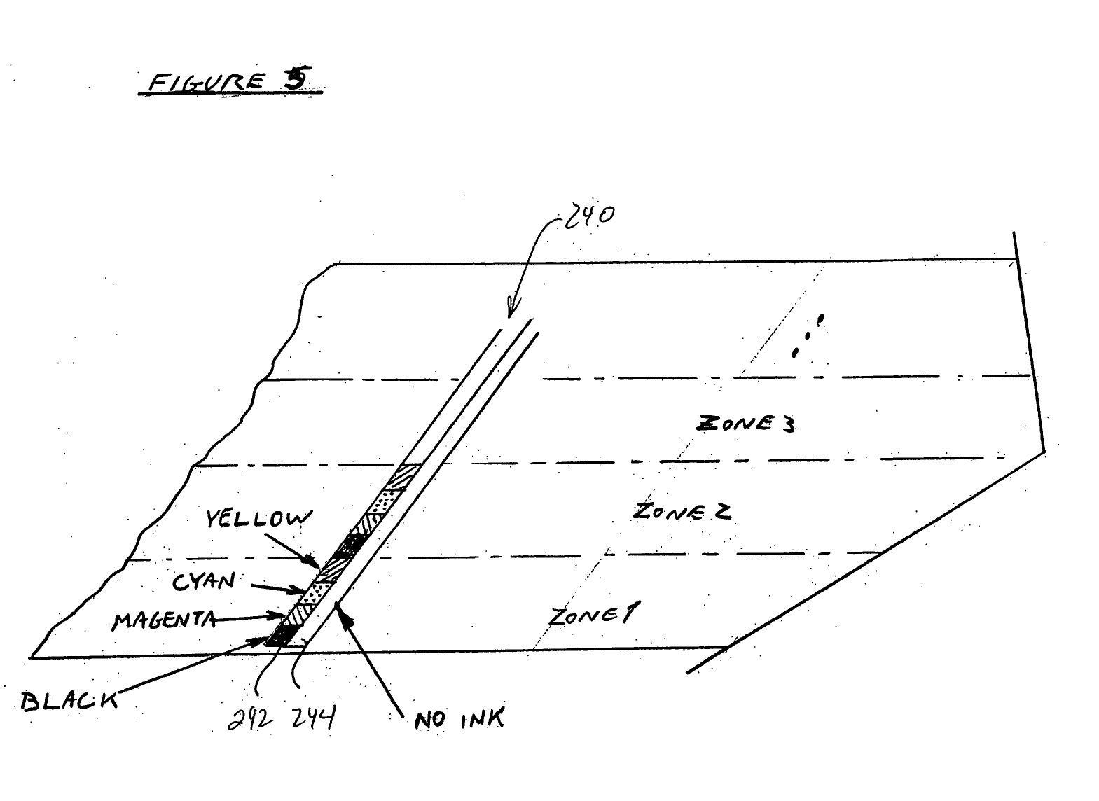

Printing starts during step 410, and sensor 10-1 detects the optical density (OD) of a known area of web 60 where printing of at least one color is not desired, for example an intentionally unprinted strip 244 next to a traditional printed color bar 242 of a target strip 240 as shown in FIG. 5. Sensor 10-1 makes available to control system 205 a signal representative of the OD, OD_{TEMP}. Processor 310 receives the OD signal of the sensor 10-1 via interface 320.

The processor then reduces fluid dampener for one specific color, i.e. one print couple, from metering device 230 in step 420, until the processor 310 determines that ODtemp is greater than ODpap. If ODtemp is greater than ODpap, it is concluded that the print for that color is scumming.

In response, at block 430, processor 310 sends a control signal to increase dampener solution to dampener solution metering device 230, via interface 320 and communications link 70. The dampener solution metering device 230 receives the control signal, via its interface, and adjusts solenoid frequencies to increase the flow rate of dampener solution from the nozzles.

Processor 310 compares the real time ODtemp data to the ODpap data and continues to send a control signal to dampener solution metering device 230 to increase dampener solution, preferably just until it receives a signal from processor 310 indicating that ODtemp equals ODpap, which may be considered the optimal dampener setting. An additional predetermined increase in the feed of the dampener solution can be provided as well, for example a value set by an operator.

If a multicolor press is used, the process can be continued for each color to be printed, for each side of the web 60.

The foregoing merely illustrates the principles of the invention. It will thus be appreciated that those skilled in the art will be able to devise numerous other arrangements which embody the principles of the invention and are thus within its sprit and scope.

For example, in the disclosed embodiment, the OD sensors are used. However, in another embodiment of the invention, the sensors can be part of a light intensity measurement system which could be used to detect small amounts of scum. This could improve the signal-to-noise ration over the OD sensors. Although any sensor capable of detecting ink on paper can be used in accordance with the invention.

In another example, based on the above disclosure, it is apparent that the principles of the invention can readily accommodate a perfecting press, where the dampener sensing system can define the optimum dampener settings on both sides of the web.

The certain color may be black and the printing press a single color press.

On a multicolor press, the OD measurement device can be used to detect each of the different inks in the non-image areas. Thus, enabling the system to define the optimum dampener settings in every printing couple.

Further, the system can be used to define the optimum dampener setting at any number of positions across the web. The control system can be used to define the optimal cross-web dampener profile. The profile being a function of the dampener design. For example, in a Duotrol dampener, the pan roll speed can be used to increase the overall volume of fluid. The skew adjustment can be used to vary the profile of the dampener from the centerline to the edges. In a spray dampener, the optimal flow rate can be defined for each water zone. The number of measurements to be taken across the web will be determined by the accuracy desired and the degrees of freedom of the dampener. The locations of the measurements could be determined by the ink coverage across the web.

Moreover, multiple sensors can be used to define the optimum dampener settings across the web, or a sensor head could travel across the web and take multiple readings.

On a press equipped with an online OD measurement system, the existing equipment can be used with the dampener sensing system in accordance with the invention. With minimal additional hardware, the OD measurement system can be enhanced.

Further, a dedicated no-ink band on the printed form is not required. The sensor can read any area in which scum can be sensed. For example, Cyan scum can be sensed in any Yellow or Magenta target. Scum can also be sensed in any open screen (screens would be required for dot-gain and contrast tests).

Additionally, a “dampener percent above scum” parameter can be set to a value to provide a factor of safety to scumming. The value can be fixed or operator adjustable.

The dampener settings could be optimized at the start of a new job or at the printer's command during a job. The optimization process is timed such that minimal additional set up time is generated.

Fluid as used herein can include a solution.

Finally, the system and method are disclosed above in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors such as digital signal processors (DSPs), microcontroller, microprocessor or system on a chip. Thus, for example, control system 205 may be realized by one or more DSPs, microcontrollers, microprocessors or system on a chip and/or a combination of digital logic devices and other components running a software program or having functions programmed in firmware.

What is claimed is:

1. An apparatus for controlling dampener fluid flow for printing comprising:
a sensor for detecting ink on a material to be printed;
a dampener fluid metering device providing dampener fluid for a certain color;
a processor connected to the sensor, the processor controlling metering of dampener fluid and determining scumming of the certain color on the material to be printed, the processor controlling the dampener fluid metering device as a function of the scumming.

2. The apparatus of claim 1 wherein the sensor is an optical density sensor.

3. The apparatus of claim 1 wherein the sensor is a light intensity sensor.

4. An offset lithographic web printing press comprising the apparatus as recited in claim 1.

5. A method for controlling dampener fluid flow in a printing press comprising:
operating the printing press so that an area of a material to pass through the printing press is not printed by a certain color;
reducing a feed of dampener fluid for the certain color;
determining when the area scums with the certain color using a processor; and
increasing the feed of the dampener fluid for the certain color using the processor so that the area does not scum with the certain color.

6. The method as recited in claim 5 wherein the increasing step includes determining, using the processor, when the area does not scum.

7. The method as recited in claim 6 wherein the feed is increased just until the area does not scum.

8. The method as recited in claim 7 wherein the feed is further increased by a predetermined amount.

9. The method as recited in claim 5 wherein the determining when an area scums is a function of measuring optical densities.

10. The method as recited in claim 5 further comprising determining whether the area or another area scums with a second color, the area or the other area not intended to be printed by the second color.

11. The method as recited in claim 5 wherein the printing press is an offset lithographic web printing press.

12. The method as recited in claim 5 further comprising predetermining a quality of the material and using the predetermined quality in the determining of when the area scums.

13. The method as recited in claim 5 wherein the material is paper.

14. The method as recited in claim 5 wherein the area is not printed by any color.

15. The method as recited in claim 5 wherein the area is printed by a color other than the certain color.

16. The method as recited in claim 5 wherein the certain color is black.

17. A method for controlling dampener fluid flow in a printing press comprising:
determining a first optical density of an area of a printing material to be passed through the printing press, the area being free of ink of a certain color;
operating the printing press so that the area is not intended to be printed by the certain color and monitoring the optical density of the area;
reducing a feed of dampener fluid for the certain color until the optical density surpasses the first optical density; and
increasing the feed of the dampener fluid so that area does not scum with the certain color.
